(19) United States
(12) Patent Application Publication
(10) Pub. No.: US 2017/0277431 A1
(43) Pub. Date: Sep. 28, 2017

(54) SEMICONDUCTOR DEVICE, SEARCH SYSTEM AND SEARCH METHOD

(71) Applicant: Renesas Electronics Corporation, Tokyo (JP)

(72) Inventor: Yasuto KURODA, Tokyo (JP)

(21) Appl. No.: 15/409,567

(22) Filed: Jan. 19, 2017

(30) Foreign Application Priority Data
Mar. 23, 2016 (JP) 2016-058581

(51) Int. Cl. G06F 3/06; G06F 12/10

(52) U.S. Cl. CPC G06F 3/061; G06F 3/064; G06F 3/0673; G06F 12/10; G06F 2212/65

(57) ABSTRACT

The present invention relates to a semiconductor device capable of providing extensibility in the entry direction and bit direction of a search table. The semiconductor device includes: a block search circuit that searches each of a plurality of block tables into which a search table, which is configured in the entry direction and in the bit direction, is divided in the entry direction and in the bit direction; a circuit that combines the search results of the block search circuits in the bit direction; and a control circuit that inputs a search key as well as the outputs of the combining circuits, and outputs hit information.

### CROSS-REFERENCE TO RELATED APPLICATIONS

The disclosure of Japanese Patent Application No. 2016-058581 filed on Mar. 23, 2016 including the specification, drawings and abstract is incorporated herein by reference in its entirety.

### BACKGROUND

The present invention relates to a semiconductor device and is applicable, for example, to a semiconductor device including a search circuit.

Japanese Unexamined Patent Application Publication No. 2013-37750 (Patent Document 1) discloses that “a content reference memory of an embodiment of the present invention includes a memory array that includes a plurality of banks in which IP addresses to be searched are stored. The memory array includes a plurality of blocks each having a variable number of banks. IP addresses with the same prefix are stored in the banks of the same block. The content reference memory further includes: a pre-search unit that receives an IP address as search data and performs a pre-search to determine which block stores the same IP address as the search data; and a search determination unit that compares the search data with the IP address read from the block identified by the pre-search.”

### SUMMARY

In Patent Document 1, when a table is generated, a table block is first formed for each prefix and then a search key of the same length is stored in each table block. Each table block is extensible in the entry direction, but not expected to be extended in the bit direction and thus has poor flexibility.

These and other objects and novel features of the present invention will become apparent from the following detailed description when read in connection with the accompanying drawings.

A typical configuration of the present invention will be briefly described below.

That is, a semiconductor device includes: a block search circuit that searches each of a plurality of block tables into which a search table, which is configured in the entry direction and the bit direction, is divided in the bit direction; and a circuit that combines the search results of a plurality of block search circuits in the bit direction.

According to the semiconductor device described above, it is possible to provide extensibility in the bit direction.

### BRIEF DESCRIPTION OF THE DRAWINGS

FIG. 1 is a diagram illustrating a configuration of a search table according to an example;

FIG. 2 is a block diagram illustrating a configuration of an ASE according to an example;

FIG. 3 is a diagram illustrating an example of the search process of ASE blocks in the bit direction;

FIG. 4 is a block diagram illustrating a configuration of a merge circuit of FIG. 2;

FIG. 5 is a block diagram of a configuration of an ASE block of FIG. 2;

FIG. 6 is a block diagram illustrating a configuration of a search device of FIG. 5;

FIG. 7 is a diagram illustrating the relationship of Multi Match information using an address reference table and a map table;

FIG. 8A is a block diagram illustrating the configuration of the map table according to an example;

FIG. 8B is a block diagram illustrating a configuration of a map table according to a first variation;

FIG. 8C is a block diagram illustrating a configuration of a map table according to a second variation;

FIG. 8D is a block diagram illustrating a configuration of a map table according to a third variation;

FIG. 9A is a block diagram illustrating the connection between ASE blocks of the ASE according to an example;

FIG. 9B is a block diagram illustrating a configuration of a map table according to a fourth variation;

FIG. 10 is a diagram illustrating a configuration of ASE-d according to a fifth variation;

FIG. 11 is a diagram illustrating an ASE block of FIG. 10;

FIG. 12 is a diagram illustrating a configuration of a search device of FIG. 10;

FIG. 13 is a diagram illustrating a configuration of a reference table of FIG. 10;

FIG. 14 is a diagram illustrating a configuration of a map table of FIG. 10;

FIG. 15 is a diagram illustrating a configuration of ASE-c according to the fifth variation;

FIG. 16 is a block diagram illustrating a configuration of a semiconductor device according to an embodiment;

FIG. 17 is a block diagram illustrating a configuration of a system according to an example; and

FIG. 18 illustrates the command for the ASE of FIG. 16.

### DETAILED DESCRIPTION

Hereinafter, embodiment, example, and variations will be described with reference to the accompanying drawings. However, in the following description, like components are denoted by like reference numerals and their description will not be repeated.

FIG. 16 is a block diagram illustrating a configuration of a semiconductor device according to an embodiment. A semiconductor device 10 according to the embodiment includes: a block search circuit (ASE Block) 11 that searches each of a plurality of block tables into which a search table, which is configured in the entry direction and in the bit direction, is divided in the bit direction; and a circuit (merge circuit) 12 that combines the search results of a plurality of block search circuits in the bit direction.

According to the embodiment, it is possible to handle a situation in which multiple hits occur in the block search circuit, with an ability to flexibly extend or shorten in the bit direction. With this configuration, it is possible to handle a search key of variable length.

### Example

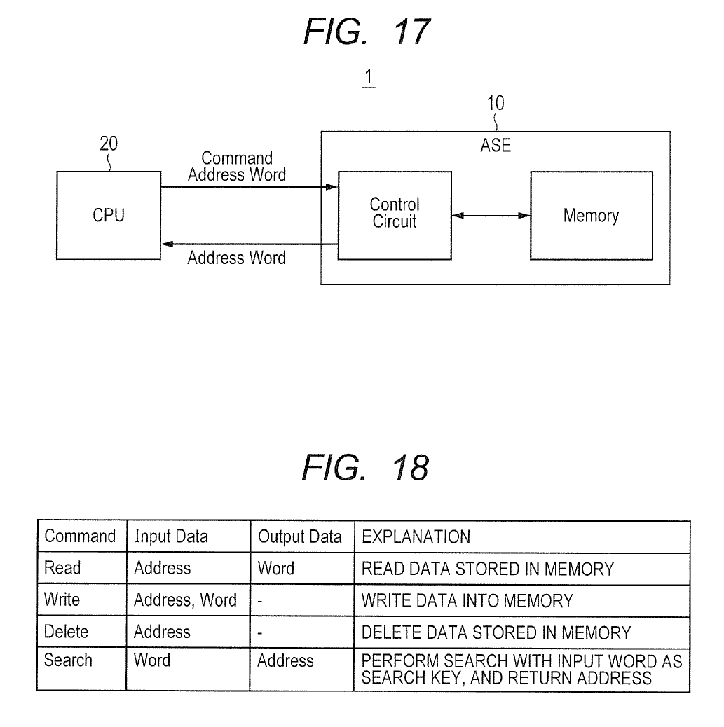

A system according to an example will be described with reference to FIGS. 17 and 18. FIG. 17 is a block diagram illustrating a configuration of a system according to an example. FIG. 18 illustrates the command for ASE of FIG. 17. A system 1 is provided with an algorism search engine (ASE) 10 which is a search circuit, as well as a CPU 20 that controls the ASE 10. The ASE 10 includes a memory and a control circuit. The memory is configured with standard DRAM or SRAM memory (hereinafter referred to as RAM) cells, instead of content addressable memory (CAM) cells. The ASE 10, which is the semiconductor device, can be configured on a single semiconductor chip or configured such that the memory and the control circuit are separately formed on different semiconductor chips.

The system has command, address, and word as an input interface from the CPU 20 of the ASE 10, and has address and word as an output interface to the CPU 20. As shown in FIG. 18, the command includes the following four types: read, write, delete, and search. The read command inputs an address and read the data stored at the address of the memory. The write command inputs an address and data and writes the data into the address of the memory. The delete command inputs an address and deletes the data stored in the memory at the address. The search command performs search with an input word as a search key and returns an address.

In the ASE, RAM is assigned as a storage medium to a search device. By using RAM as the storage medium that configures the search device, it is possible to reduce power consumption more than the case of using TCAM.

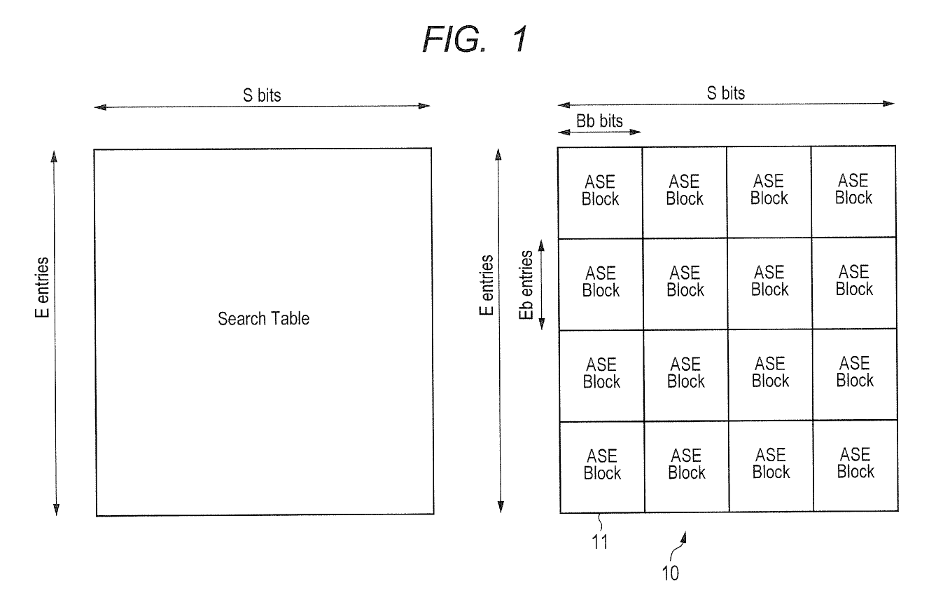

The search table will be described with reference to FIG. 1. FIG. 1 is a diagram illustrating an example of how to store a search table in the ASE. The search table is configured with E entries. One entry has S bit length. In the ASE 10, the search table is divided into sections in the bit direction and in the entry direction. Each section is stored in the corresponding ASE block 11. The ASE block 11 is configured with Eb entries. One entry has Sb bit length. The ASE 10 can be flexibly extended or shortened in the entry direction and in the bit direction. The architecture of the search table can have ASE blocks 11, each corresponding to the prefix length of the IP address.

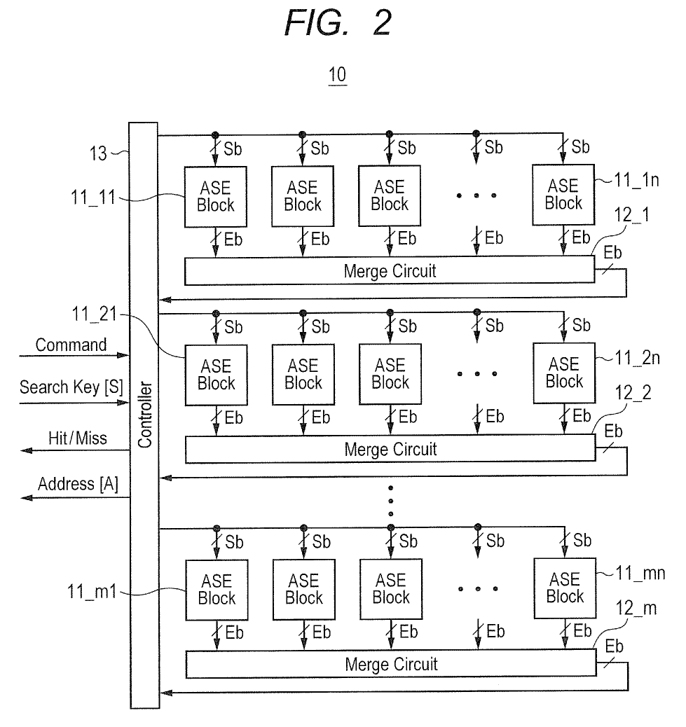

The configuration and search operation of the ASE 10 will be described with reference to FIG. 2. FIG. 2 is a block diagram illustrating the configuration of the ASE. The ASE 10 includes: m ASE blocks 11 in the entry direction and n ASE blocks 11 in the bit direction, thus m×n ASE blocks 11 in total (11_11, . . . 11_1n, 11_21, . . . , 11_2n, 11_m1, . . . , 11_mn); m merge circuits 12 (12_1, 12_2, . . . , 12_m): and a controller 13.

(1) The controller 13 receives a search command and a search key [S] of S bit length and equally divides the search key by the number of blocks. Then, the controller 13 transmits the block search keys into which the search key is divided by Sb bit length, to the respective ASE blocks 11.

(2) Each ASE block 11 performs a matching comparison between the input block search key and the divided search table (sub table) stored in the ASE block 11. Then, the ASE block 11 outputs the result. The table search may hit a plurality of entries with one search key. This is defined as Multi Match. Thus, each ASE block 11 outputs Multi Match result in the particular ASE block. The process of Multi Match in the bit direction is described below in (3), and the process of Multi Match in the entry direction is described below in (4).

(3) The merge circuit 12 combines the results output from the respective ASE blocks 11 for each of the entries in the bit direction. The details are described below.

(4) The controller 13 combines the outputs of the merge circuits 12 in the entry direction by an encoder not shown. At this time, when there are a plurality addresses of the search table, which are output results, due to Multi Match, the encoder selects one result according to the priority. The controller 13 outputs an address of A bit length (Address [A]) as well as hit information (Hit/Miss).

The controller 13 performs the timing control and input/output control of the whole device. Upon input, the controller 13 properly processes the input data according to the command input from the outside. Upon searching, the controller 13 performs a merge process and an encoder process.

Each ASE block 11 is provided with RAM, which enables search process with a single ASE block.

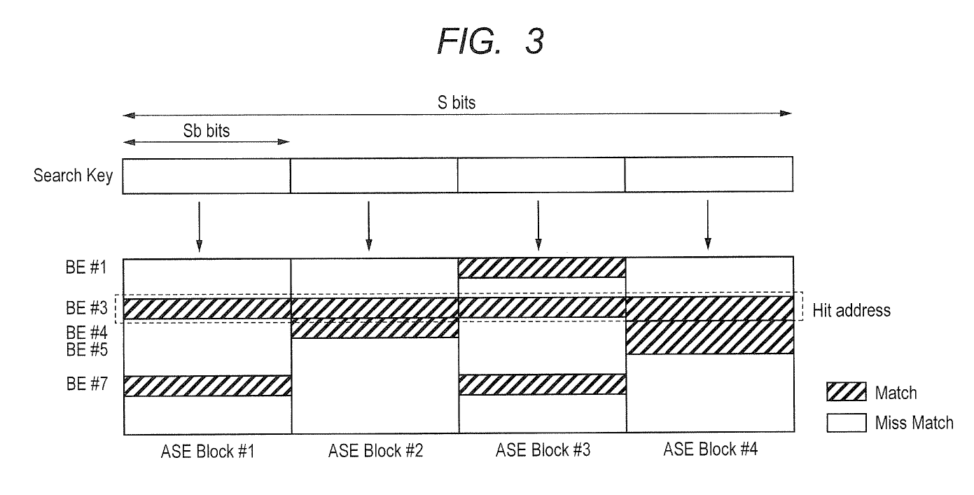

The search process of the ASE block 11 will be described with reference to FIG. 3. FIG. 3 is a diagram illustrating an example of the search process of ASE blocks arranged in the bit direction. As described above, the search results of the respective ASE blocks 11 may include Multi Match results for each of the divided search keys (block search keys). The block search key of ASE block #1 matches two entries, or the third block entry (BE #3) and the seventh block entry (BE #7). The block search key of ASE block #2 matches two entries, or the third block entry (BE #3) and the fourth block entry (BE #4). The block search key of ASE block #3 matches three entries, or the first block entry (BE #1), the third block entry (BE #3), and the seventh block entry (BE #7). Then, the block search key of ASE block #4 matches three entries, or the third block entry (BE #3), the fourth block entry (BE #4), and the fifth block entry (BE #5). The address stored in the entries that the search key of all the ASE blocks #1 to #4 matches is the hit address. Thus, if a matching search result is defined as “High”, the search results of the ASE blocks 11 arranged in the bit direction are logically multiplied by the merge circuit 12 to obtain one search result. Further, the output result (search result) of the ASE block 11 indicates that the position of data “High” is the matching address of the block search table.

Note that the search results of the ASE blocks 11 arranged in the entry direction are combined by the encoder as described above. The encoder functions as a priority encoder and outputs one search result according to the priority upon occurrence of Multi Match.

Next, the merge circuit (combining circuit) will be described with reference to FIG. 4. FIG. 4 is a block diagram illustrating the configuration of the merge circuit. The merge circuit 12 includes a multiplexer 121, an AND circuit 122, and a register (FF) 123.

First, the multiplexer 121 of the merge circuit 12 selects the search result of Eb bit of the ASE block #1, and the AND circuit 122 obtains the logical product of the register 123. At this time, the register 123 is initialized such that all Eb bits are set to “High”. The output of the AND circuit 122 (the search result of the ASE block #1) is input to the register 123.

Next, the multiplexer 121 of the merge circuit 12 selects the search result of Eb bit of the ASE block #2, and the AND circuit 122 obtains the logical product of the register 123. At this time, the resister 123 stores the search result of the ASE block #1. The output of the AND circuit 122 (the logical AND of the search result of the ASE block #1 and the search result of the ASE block #2) is input to the register 123.

Then, in response to the input of the search result of the ASE block #3 and the input of the search result of the ASE block #4, the logical product of the search result of the ASE block #1, the search result of the ASE block #2, the search result of the ASE block #3, and the search result of the ASE block #4 is stored in the register 123.

In this way, the search results of the ASE blocks are combined in the bit direction by the merge circuit 12. The merge circuit 12 activates the operation of each ASE block in order of time series by using the respective functions of the ASE block, which can contribute to reduced power consumption.

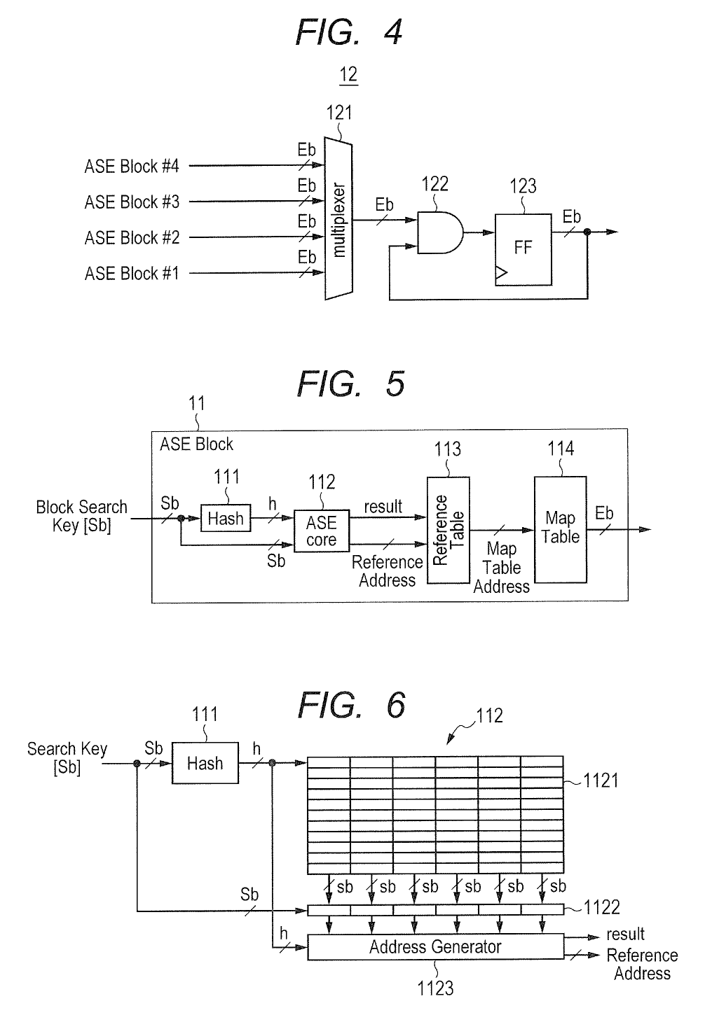

Next, the search operation of the respective functions included in the ASE block 11 will be described with reference to FIG. 5. FIG. 5 is a block diagram illustrating the configuration of the ASE block. The ASE block 11 includes a hash calculating circuit 111, a search device (ASE core) 112, a reference table 113, and a map table 114.

The hash calculating circuit 111 calculates a hash value (h) from a block search key [Sb], which is input data, by a hash function. The hash value (h) is used to determine the word line to be read from a memory array 1121 that configures the subsequent search device 112. In other words, the hash value (h) represents the line address of the memory array 1121. The hash calculating circuit 111 is provided to prevent variation in data stored in the search device 112.

The search device 112 compares the input data (block search keys) with the values of the tables (divided search tables) that are all read at the same time from the memory array 1121. Then, the search device 112 outputs the search result (result, reference address). The details are described below.

The reference table 113 is the table that has the map address referred to in the map table 114.

The map table 114 is the table that holds Multi Match information of the sub tables stored in the ASE block 11.

Next, the search device 112 will be described with reference to FIG. 6. FIG. 6 is a block diagram illustrating the configuration of the search device. The search device 112 is provided with the memory array 1121 configured with RAM, a comparator 1122, and an address generator 1123. The search device 112 compares the input block search keys with the stored divided search tables. The input to the search device 112 is the address information obtained from the previous hash calculating circuit 111 to select the word line to be read. After the word line is determined, the search device 112 reads all the memory cells and compares the read data with the data to be searched. The search device 112 includes the comparators 1122 for the number of bits of the memory array 1121 in the bit direction in order to compare each of the read bits, as well as the address generator 1123. The value stored in the memory array 1121 of the ASE block 11 includes the search keys (obtained by dividing the original search key, which are the inputs of the respective ASE blocks 11), and one bit of Valid that is used to control the reading of the value from the memory. When the value is stored in the search device 112, the hash value of the search key is calculated. Then, the hash value is used as the address of the memory array 1121 where the value is stored.

In the case of storing a plurality of entries, sometimes the hash values calculated from a plurality of search keys are the same. This is called a hash collision. When a hash collision occurs, the value is added to the memory array 1121 on the word line. The number of search keys that can be stored in the RAM 1121 on one word line is six in FIG. 6, but it depends on the number of bits in the bit direction. The hash calculating circuit 111 optimizes the hash function to average deviation in the distribution of hash collisions in order to effectively use the memory array 1121.

Further, as described with reference to FIG. 3, the search key stored in the ASE block 11 is the value obtained by dividing the original search data. Thus, if entries store a value whose original search data is different, the search key may match the entries being treated as the same value in terms of a single ASE block (Multi Match). When Multi Match occurs, the value is not added to the memory array 1121 of the search device 112, but is added as Multi Match information into the map table 114.

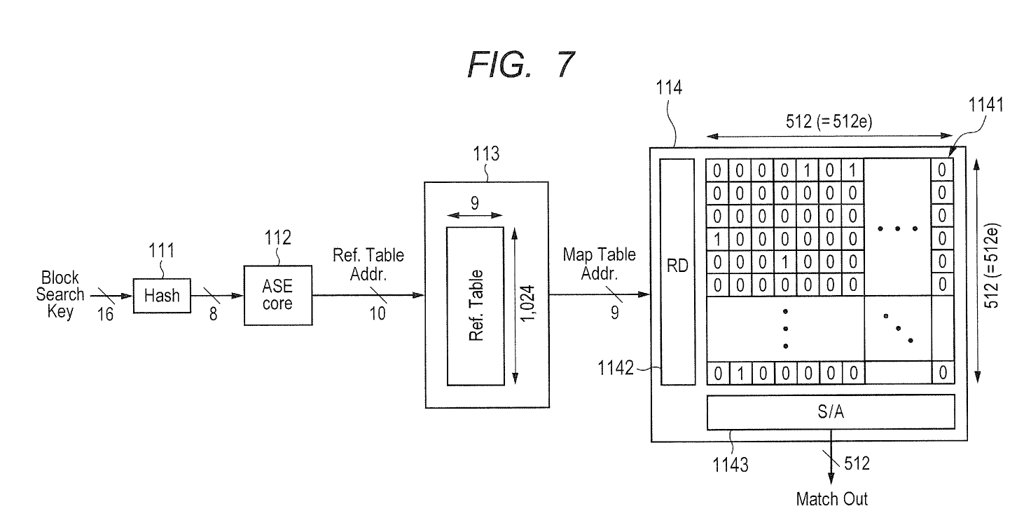

Next, the output of the Multi Match information will be described with reference to FIG. 7. FIG. 7 is a diagram illustrating the relationship of the Multi Match information using the address reference table and the map table. Here, it is assumed that the block search key is 16 bit length (Sb=16) and the number of entries is 512 (Eb=512). In this case, the hash calculating circuit 111 outputs a hash value of 8 bits. The output of the search device 112 includes the hit result and reference address relating to the search. The reference address is an address of 10 bit length, including the hash value (8 bits) used in the address selection of the search device 112 as well as the value (2 bits) that indicates the column number of the search device 112.

The reference table 113 is a table that stores the address information (map table address (9 bits)) referred to in the map table 114. The reference table 113 is configured with RAM (memory). The map table 114 stores the Multi Match result within the ASE block 11. The map table 114 includes a memory array 1141 configured with RAM, a row decoder (RD) 1142, and a sense amplifier (S/A) 1143. In the map table 114, the bit in which “1 (High)” is stored on the entry matches, and Multi Match occurs with a plurality of entries marked with “High”. Further, in the map table 114, the positions of bits in which “High” is stored are the addresses (entries) of Multi Match. For example, in the top row of the map table 114, both the fifth and seventh bits from the left store “High”, so that Multi Match occurs in the fifth and seventh entries. Because the map table 114 is read in units of rows, the match information of all the entries is read at the same time.

The merge circuit 12 is provided to handle the situation in which a plurality of hits (Multi Match) occurs in the ASE block 11. As a result, it is possible to the extension of the bit length, and thus to flexibly use a search key of variable length. In this way, it is possible to expand the range of applications to deep packet inspection (DPI) aiming at monitoring all the layers L1 to L7 of each packet flowing on the network.

### First Variation

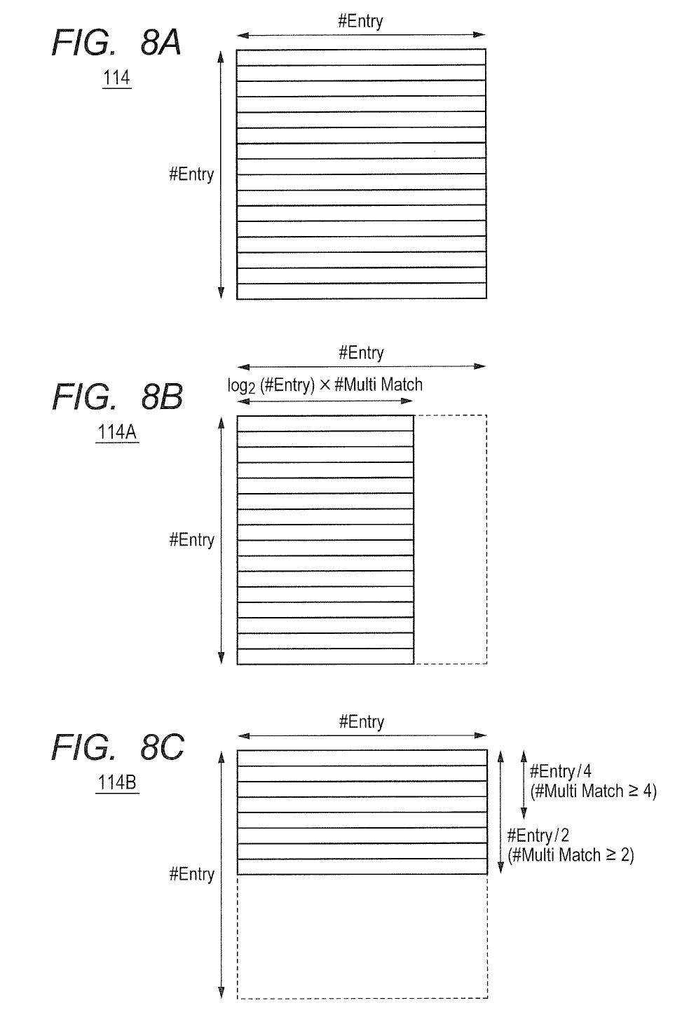

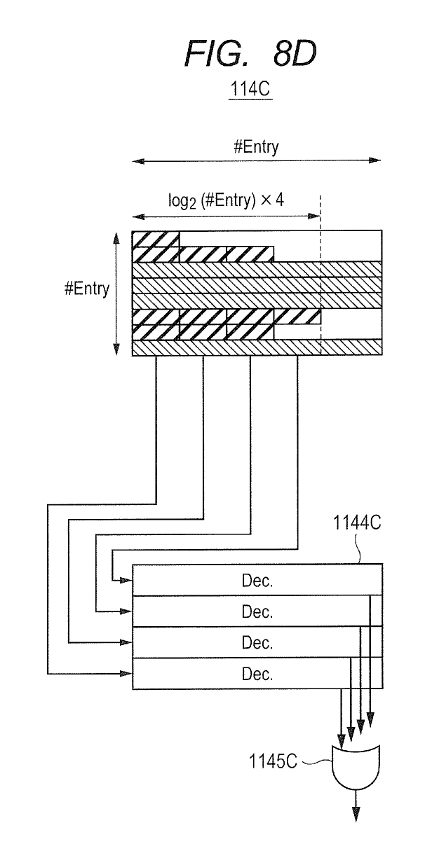

First variation is an improvement of the map table 114 that is implemented in the embodiment. A map table according to the first variation will be described with reference to FIGS. 8A and 8B. FIG. 8A is a block diagram illustrating the configuration of the map table according to the embodiment. FIG. 8B is a block diagram illustrating a configuration of a map table according to the first variation.

As shown in FIG. 8A, in the embodiment, the memory capacity required to express the Multi Match information by using the map table 114 is as follows: the number of entries (in the entry direction) of the ASE block 11 for the map table 114×the number of entries (in the bit direction) of the ASE block 11. In other words, the required memory capacity is the square of the number of entries of the ASE block 11. The memory capacity required for the map table of FIG. 7 is 512×512=262.144 bits.

For example, if data stored in the ASE block 11 is the same in all entries, Multi Match results concentrate on only one entry in the map table 114 and “High” is stored in all the bits of the particular entry. At this time, the number of bits is equal to the number of entries of the ASE block. In this case, the capacity in the entry direction is entirely useless.

On the other hand, when no Multi Match occurs, “High” is stored in one bit in each entry. At this time, “High” is not stored in the same bit in all entries.

Consequently, when match is set to “High” and mismatch is set to “Low” in the map table 114, the number of values “High” is just equal to the number of entries in the entire map table. Thus, the memory capacity of the number of entries (entry direction)×the number of entries (bit direction) is wasteful.

In the map table 114A of the first variation, as a method for compressing the memory capacity, the Multi Match information is stored as encoded data in order to reduce waste memory capacity. In the embodiment, the Multi Match information is expressed in such a way that the number of bits equal to the number of entries is prepared and “High” is stored in the matching entries. In the first variation, the matching entry information is encoded, so that the memory capacity can be compressed when the relationship “log₂ (the number of entries)×the number of occurrences of Multi Match<the number of entries” is satisfied as shown in FIG. 8B.

For example, when the number of entries is “1024”, the number of entries “1024”/log₂ (the number of entries “1024”)=102.4. Thus, the memory capacity can be reduced by setting the number of occurrences of Multi Match to 100 or less. Further, when the number of entries is set to 1024 as described above and the number of occurrences of Multi Match is set to 64, the memory capacity can be reduced to about half (more precisely, 64×10/1024=0.625). In this case, the number of decoders required is equal to the number of occurrences of Multi Match. Even if the number of occurrences of Multi Match is limited in the embodiment, the memory capacity may not be compressed in the bit direction.

### Second Variation

A map table according to a second variation will be described with reference to FIG. 8C. FIG. 8C is a block diagram illustrating a configuration of a map table according to the second variation. In a map table 114B of the second variation, the limit on the number of occurrences of Multi Match is not set to the upper limit as in case of the first variation, but is set to the lower limit so that the table can be compressed in the entry direction. As described above, in the embodiment, when the search key matches all entries in the sub table (the number of occurrences of Multi Match=the number of entries), only one row of the map table 114 is used. When the search key matches only one entry in the sub table (the number of occurrences of Multi Match=1), all the rows of the map table 114 are used. In other words, by increasing the lower limit of the number of occurrences of Multi Match, it is possible to reduce the number of rows of the map table in the entry direction.

For example, when the lower limit of the number of occurrences of Multi Match stored in the map table 114B is set to “4”, the number of rows in the entry direction can be reduced to one fourth. Further, the number of rows in the entry direction can be reduced to one half by only setting the lower limit of the number of occurrences of Multi Match to “2”. As described above, the proposed method that can also compress the map table with feasible limits is very useful.

In the embodiment, supporting all cases results in a wasteful situation, which is improved in the first and second variations by setting some limits (limitations according to the actual use) to allow compression of memory capacity.

### Third Variation

A map table according to a third variation will be described with reference to FIG. 8D. FIG. 8D is a block diagram illustrating a configuration of a map table according to the third variation. A map table 114C of the third variation changes the address management method according to the allocation rate of addresses.

When the number of occurrences of Multi Match is 4 or less, each address is encoded and stored in the map table 114C similarly to the first variation. When the number of occurrences of Multi Match is 5 or more, “High” is stored in the specified location of the map table 114C similarly to the embodiment.

The operation performed in the entry direction is the same as the operation of the embodiment. The operation performed in the bit direction is different from the operation of the embodiment.

A way to store data in the map table 114C is to first store the encoded information. When the number of entries is set to “1024”, the encoded information is stored for every 10 bits. Next, when the search operation is performed, all data stored in the entries are read and the encoded information is decoded by a decoder 1144C. Further, all the decoded data are logically summed by an OR circuit 1145C to put the Multi Match information together into a whole. For this reason, the number of decoders required is equal to the number of occurrences of Multi Match. This is also applied to the first variation.

### Fourth Variation

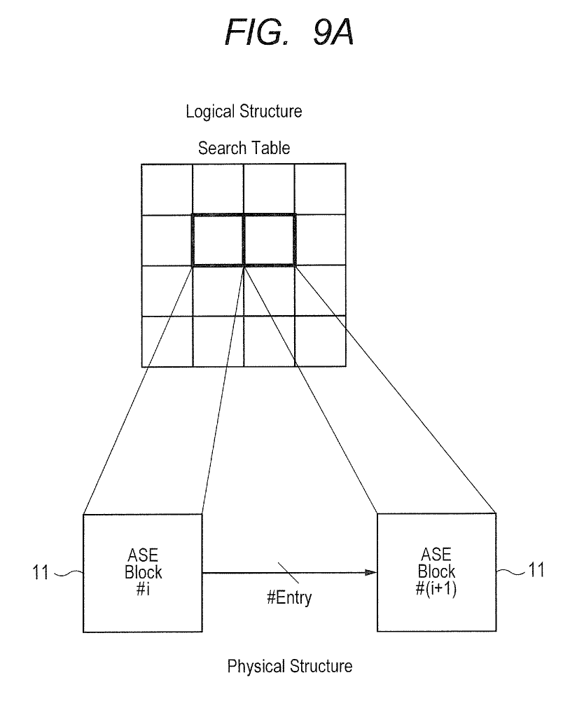

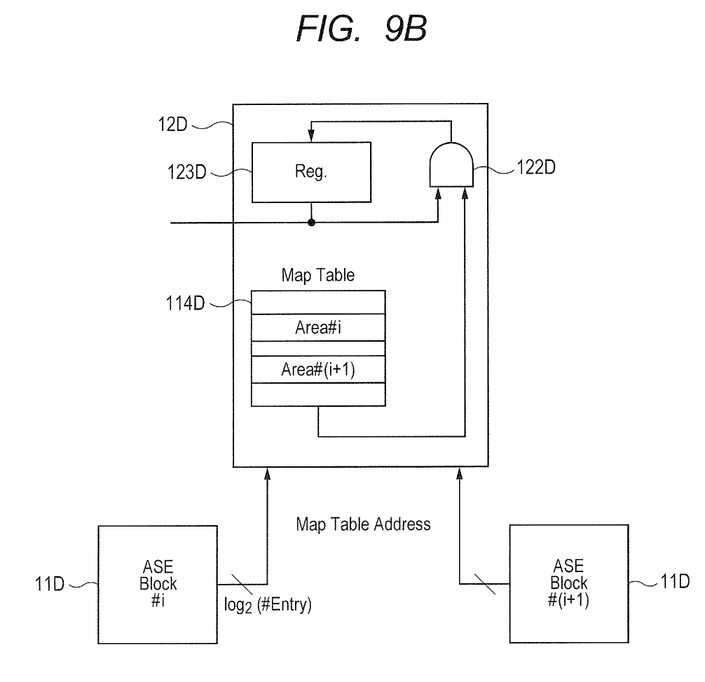

Fourth variation is an improvement of the map table by a method different from the method of the first variation. A map table according to the fourth variation will be described with reference to FIGS. 9A and 9B. FIG. 9A is a block diagram illustrating the connection between ASE blocks of the ASE according to the embodiment. FIG. 9B is a block diagram illustrating a configuration of a map table according to the fourth variation.

As described in the embodiment, after the search process is performed in each ASE block 11, it is necessary to combine the Multi Match information by using the merge circuit 12. If each of the ASE blocks 11 inputs Multi Match information into the multiplexer 121 of the merge circuit 12, the number of required lines increases. Thus, for example, the multiplexer of the merge circuit is divided and placed in each ASE block, in which Multi Match information input from the left adjacent ASE block is multiplexed with the Multi Match information of the particular ASE block and is transmitted to the right adjacent ASE block. In this way, as shown in FIG. 9A, each ASE block 11 transmits information by connecting a line for the number of entries that represent the Multi Match information, as input and output, to the adjacent ASE blocks. However, for example, when the number of entries is set to “1024”, the information is propagated along a line of 1024 bits and difficulty is expected when considering its implementation.

Thus, in the fourth variation, the map table is treated as a shared memory to eliminate the need to connect a line for the number of entries as input and output by each ASE block, and a merge circuit 12D is formed by combining the map table and the merge circuit. Thus, the merge circuit 12D includes a map table 114D, an AND circuit 122D, and a register 123D.

The ASE block 11D according to the fourth variation includes the hash calculating circuit 111, the search device 112, and the reference table 113. Although the reference table and the map table are mounted on each ASE block in the embodiment, this connection relationship is separated in the fourth variation. The search process in each ASE block 11D is completed in the reference table 113, and the output data of the reference table 113, which is the search result to each ASE block 11D, is transferred to the map table 114D of the merge circuit 12D. At this time, a line of log₂ (the number of entries) is connected to the map table 114D from each ASE block 11D. In this way, the number of connected lines can be reduced.

The operation in the fourth variation needs to be controlled so that the ASE blocks 11D do not access the map table 114D, which is the shared memory, at the same time. For example, the ASE blocks 11D access the map table 114D sequentially from the ASE block 11D on the left side. In this case, each ASE block receives a signal form the left adjacent ASE block that notifies of completion of the access and then accesses map table 114D.

(1) A search key is given to the ASE block #1. At this time, the ASE block 11D performs a search process and transfers the output result of the reference table 113 to the area #1 of the map table 114D. The map table 114D outputs Multi Match information according to the input value (address). Then, the Multi Match information is stored in the register 123D.

(2) A search key is given to the ASE block #2. At this time, the ASE block 11D performs a search process and transfers the output result of the reference table 113 to the area #2 of the map table 114D. The map table 114D outputs Multi Match information according to the input value (address). At the same time, the value is read from the register 123D to obtain the logical product (“AND”) of the Multi Match information and the value of the register by using the AND circuit 122D. Then, the result is stored in the register 123D.

(3) The same process as the process described in (2) is performed until the ASE block #n.

The mounting area can be reduced by sharing the memory of the address through one line of a large bit width (# entry). The reduction in the mounting area can also contribute to a reduction in the power consumption.

### Fifth Variation

When ASE is provided as IP to the field programmable gate array (FPGA) or other similar device, the usable memory capacity is limited but the use scene varies depending on the user. Further, when ASE is implemented in FPGA, limitations in the entry direction and the bit direction arise due to the finite resources available.

Thus, in the fifth variation, the same ASE block is flexibly used depending on the application of either expansion in the entry direction or expansion in the bit direction. The ASE according to the fifth variation is used appropriately either as ASE-d extending in the entry direction or as ASE-c extending in the bit direction.

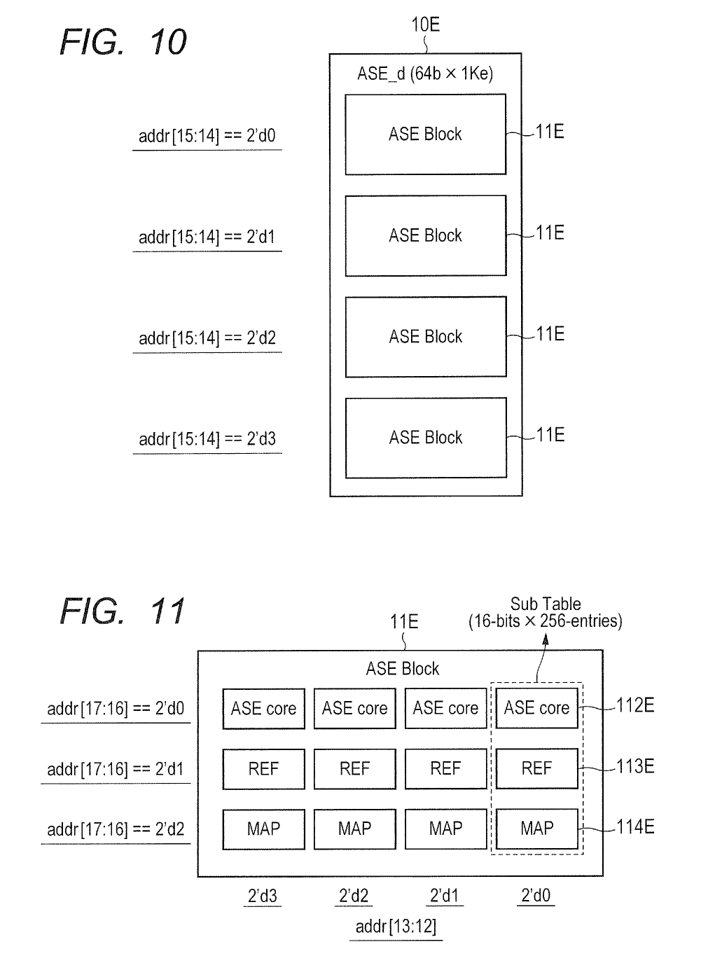

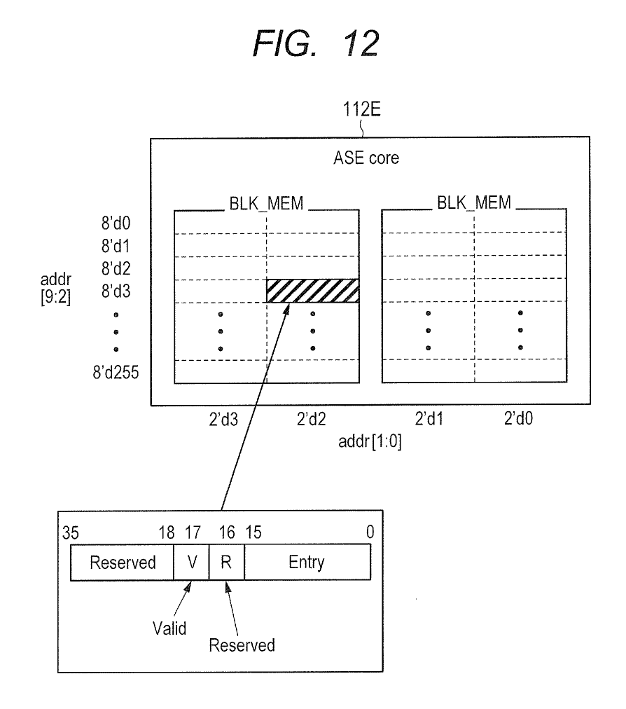

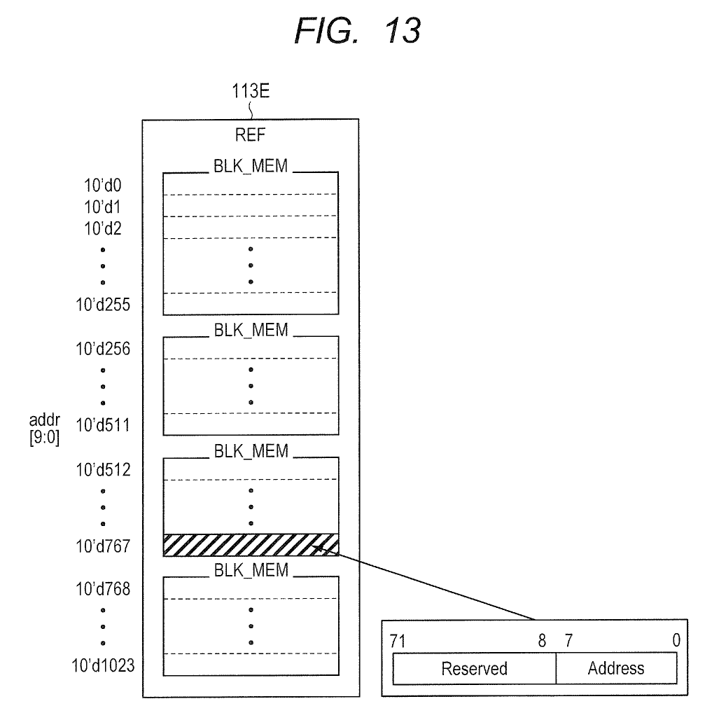

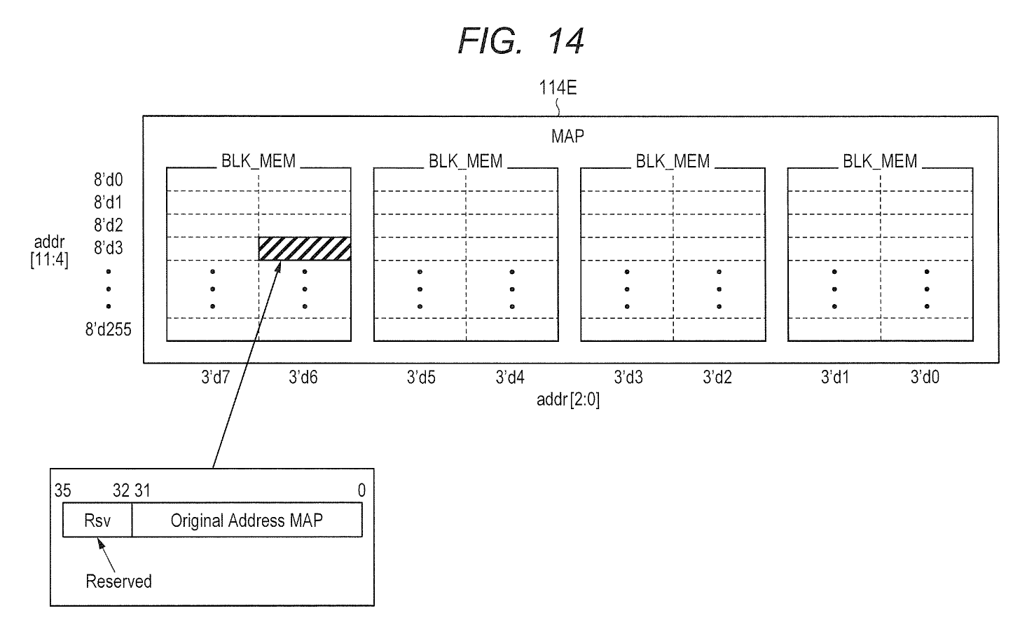

The ASE-d according to the fifth variation will be described with reference to FIGS. 10 to 14. FIG. 10 is a diagram illustrating the configuration of the ASE-d according to the fifth variation. FIG. 11 is a diagram illustrating the configuration of the ASE block of FIG. 10. FIG. 12 is a diagram illustrating the configuration of the search device of FIG. 10. FIG. 13 is a diagram illustrating the configuration of the reference table of FIG. 10. FIG. 14 is a diagram illustrating the configuration of the map table of FIG. 10.

(1) As shown in FIG. 10, ASE-d 10E has 64 bits×1024 entries, extending in the entry direction. The ASE-d 10E is provided with four ASE blocks 11E, each of which is controlled by using two bits of address addr[15:14]. The extension is controlled in the entry direction.

(2) As shown in FIG. 11, the ASE block 11E selects a set of search device (ASE core) 112E/reference table (REF) 113E/map table (MAP) 114E by using two bits of addr[17/16]. Each search device 112E searches 16 bits and the ASE block 11E searches 16 bits×4=64 bits, which are controlled with two bits of addr[13:12]. Then, the reference table 113E and the map table 114E are provided in each search device 112E.

(3) As shown in FIG. 12, the search device 112E determines the depth according to the hash collision probability by using addr[1:0]. Further, the search device 112E holds 256 entries in the entry direction by using addr[9:2]. In the search device 112E, data of 36 bits are stored. Of these bits, the valid bit (V) is stored at [17] and the block search key (Entry), which is the search target data, is stored at [15:0]. [35:18] and [16] are reserved (R). When data is written in the search device 112E, the valid bit is set to “1”. When the data is deleted, the valid bit is changed to “0”.

(4) As shown in FIG. 13, the reference table 113E manages 1024 addresses according to the addresses (10 bits of addr[9:2] [1:0]) of the search device 112E. In the reference table 113E, data of 72 bits are stored, in which the address used to access the map table 114E is stored at [7:0]. [71:8] is reserved.

(5) As shown in FIG. 14, in the map table 114E, the upper limit of the number of occurrences of Multi Match is set to 8, which is managed by using addr[2:0]. Further, with respect to the entry direction, 256 entries are managed by using addr[11:4]. In the map table 114E, data of 36 bits are stored, in which the encoded Multi Match information (original address map) is stored at [31:0]. [35:32] is reserved (Rsv).

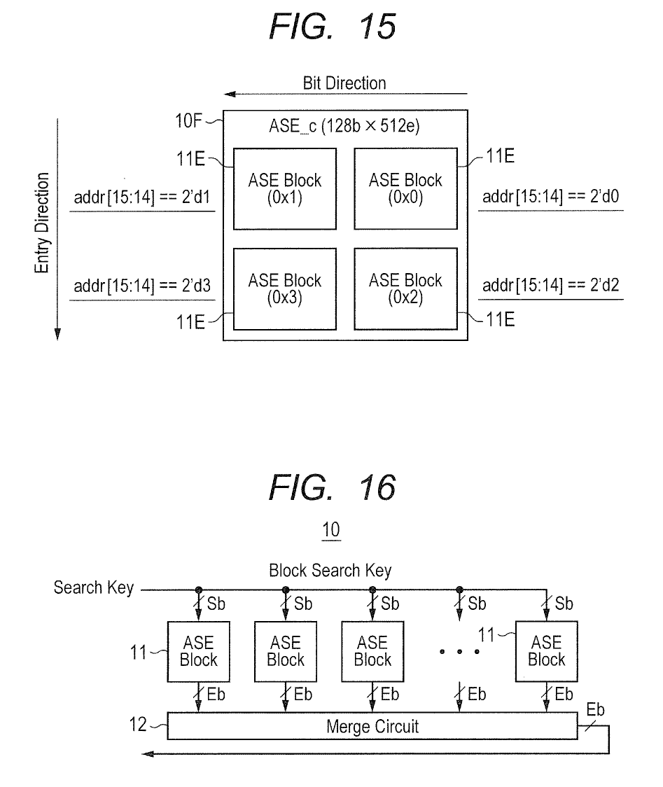

Next, ASE-c according to the fifth variation will be described with reference to FIG. 15. FIG. 15 is a diagram illustrating the configuration of ASE-c according to the fifth variation.

As shown in FIG. 15, ASE-c 10F has 128 bits×512 entries, extending in the bit direction. ASE-c 10F is provided with four ASE blocks 11E, each of which is controlled by using two bits of address addr[15:14]. The extension is controlled in the bit direction. Note that the ASE blocks 11E of the ASE-c 10F are the same as those of the ASE-d 11E, so that the configuration and control of the ASE-d 11E described in (2) to (5) are also applied to the ASE-c 11E.

When ASE is provided as IP in FPGA or other similar device, the usable memory capacity is limited but the use scene varies depending on the user. By using this method, the memory capacity can be flexibly allocated according to the use scene.

The ASEs according to the embodiment examples and the first to fifth variations can be applied, for example, to a network search engine and to a search system in which the search engine is used.

The invention made by the present inventors has been specifically described based on the embodiment, examples, and variations. However, it is needless to say that the present invention is not limited to the foregoing embodiment, examples, and variations, and various modifications and alterations can be made within the scope of the present invention.

In the description of the embodiment examples, match information is defined as “High” and combined by using the AND circuit in the merge circuit. However, it is also possible that the match information is defined as “Low” and combined by using the OR circuit in the merge circuit.

What is claimed is:

1. A semiconductor device comprising:
a plurality of block search circuits corresponding to a plurality of block tables into which a search table, which is configured in the entry direction and the bit direction, is divided in the entry direction and in the bit direction;
a plurality of combining circuits that combine the search results of the block search circuits in the bit direction; and
a control circuit that inputs a search key as well as the outputs of the combining circuits, and outputs hit information.

2. The semiconductor device according to claim 1,
wherein the block search circuit comprises:
a hash calculating circuit that calculates the hash values of block search keys into which the search key is divided;
a search device that searches the stored data by using the block search key and the hash value, and outputs a reference address;
a reference table that converts the reference address into a map address; and
a map table that is accessed by the map address and outputs the search result.

3. The semiconductor device according to claim 2,
wherein the search device comprises:
a memory that stores search target data as well as information indicating validity or invalidity of the search target data;
a comparator that compares the block search key with the search target data read from the memory by using the hash value; and
an address generator that generates the reference address based on the hash value.

4. The semiconductor device according to claim 3,
wherein the memory is configured with RAM.

5. The semiconductor device according to claim 2,
wherein the map table comprises a memory having the same number of storage locations as the squared number of entries in the block search circuit, in which a plurality of pieces of match information can be stored.

6. The semiconductor device according to claim 2,
wherein the map table comprises:
a memory that encodes match information and stores the encoded match information; and
a decoder that decodes the match information read from the memory.

7. The semiconductor device according to claim 6,
wherein the upper limit of the number of occurrences of Multi Match is set to a value smaller than the binary logarithm of the number of entries in the block search circuit.

8. The semiconductor device according to claim 1,
wherein the block search circuit comprises:
a hash calculating circuit that calculates the hash values of the block search keys into which the search key is divided;
a search device that searches the stored data by using the block search key and the hash value, and output the search result and reference address; and
a reference table that converts the reference address into a map address.

9. The semiconductor device according to claim 8,
wherein the combining circuit comprises a map table that is accessed by each of the map addresses of the block search circuits in the bit direction, and
wherein the combining circuit combines the search results read from the map table by taking the logical product or logical sum.

10. The semiconductor device according to claim 1,
wherein the combining circuit combines the search results of the block search circuits in the bit direction by taking the logical product or logical sum.

11. A search system comprising:
a plurality of block search circuits corresponding to a plurality of block tables into which a search table, which is configured in the entry direction and in the bit direction, is divided in the entry direction and in the bit direction;
a plurality of combining circuits that combine the search results of the block search circuits in the bit direction;
a control circuit that inputs the combined search result; and
a CPU that inputs a search key to the control circuit and inputs hit information from the control circuit.

12. The search system according to claim 11,
wherein the block search circuit comprises a hash calculating circuit that calculates hash values of block search keys into which the search key is divided;
a search device that searches the stored data by using the block search key and the hash value, and outputs a reference address;
a reference table that converts the reference address into a map address; and
a map table that is accessed by the map address and outputs the search result.

13. The search system according to claim 12,
wherein the search table comprises:
a memory that stores search target data as well as information indicating validity or invalidity of the search target data;
a comparator that compares the block search key with the search target data read from the memory by using the hash value; and
an address generator that generates the reference address based on the hash value.

14. The search system according to claim 12,
wherein the combining circuit combines the search results of the block search circuits in the bit direction by taking the logical product or logical sum.

15. A search method comprising the steps of:
dividing a search key into a plurality of block search keys;
searching each of a plurality of block search circuits corresponding to a plurality of block tables into which a search table, which is configured in the entry direction and in the bit direction, is divided in the entry direction and in the bit direction; and
combining the search results of the block search circuits in the bit direction.

16. The search method according to claim 15, further comprising the steps of:
calculating a hash value of each block search key;
searching the stored data by using the block search key and the hash value and outputting a reference address;
converting the reference address into a map address; and
accessing by using the map address and outputting the search result.

17. The search method according to claim 16, further comprising the steps of:
storing search target data as well as information indicating validity or invalidity of the search target data;
comparing the block search key with the search target data read by the hash value; and
generating the reference address based on the hash value.

18. The search method according to claim 16,
wherein the search results of the block search circuits in the bit direction are combined by taking the logical product or logical sum.
